(19) United States
(12) Patent Application Publication
(10) Pub. No.: US 2017/0031276 A1
(43) Pub. Date: Feb. 2, 2017

(54) METHOD AND DEVICE FOR SETTING A WORK POINT FOR A TRANSFER PROCESS IN AN ELECTROGRAPHIC DIGITAL PRINTER

(71) Applicant: Oce Printing Systems GmbH & Co. KG, Poing (DE)

(72) Inventors: Albrecht Gerstner, Oberbergkirchen (DE); Georg Landmesser, Haar (DE); Matthias Fromm, Markt Schwaben (DE); Stefan Roehl, Muenchen (DE); Thomas Montag, Unterhaching (DE); Tobias Breintner, Muenchen (DE)

(73) Assignee: Oce Printing Systems GmbH & Co. KG, Poing (DE)

(21) Appl. No.: 15/222,098

(22) Filed: Jul. 28, 2016

(30) Foreign Application Priority Data
Jul. 28, 2015 (DE) 102015112275.8

(51) Int. Cl. G03G 15/16

(52) U.S. Cl. CPC G03G 15/1665; G03G 15/0266

(57) ABSTRACT

A method and a controller operable to adjust the field strength of an electrical field for the toner transfer in an electrographic printing process. Current values of framework parameters can be determined and a control loop configured to adjust the electrical field is adapted based on current values of the framework parameters. An electrical reference variable of the control loop can be adapted to the current values of the framework parameters. The electrical reference variable can include, for example, a current and/or a voltage for the toner transfer.

### CROSS REFERENCE TO RELATED APPLICATIONS

This patent application claims priority to German Patent Application No. 102015112275.8, filed Jul. 28, 2015, which is incorporated herein by reference in its entirety.

### BACKGROUND

The disclosure is directed to a digital printer for printing to a recording medium with toner particles under the effect of an electrical field.

In electrographic digital printers, a latent charge image of an image substrate is inked with toner (for example liquid toner or dry toner). The toner image that is created in such a manner is typically transferred onto a recording medium indirectly via a transfer station. In this transfer step, an electrical field is used in order to print the toner image onto the recording medium.

Recording media may exhibit different properties (for example different thicknesses or sizes of up to 600 μm, different moisture values, different materials etc.). Furthermore, the ambient atmosphere in an environment of the transfer station of a digital printer may vary. Overall, the values of framework parameters for a printing process may thus vary significantly.

US2010/0296139A1 describes a printer in which print parameters may be adapted in order to set a specific color value. US2010/0080596A1 describes a printer in which an electrical field for the toner transfer may be set in order to increase the transfer efficiency. US2012/0177391A1 describes a printer in which the voltage for the toner transfer may be set. US2015/0037054A1 describes a printer which may be adapted to current environmental conditions. US2008/0003002A1 describes a printer in which transfer parameters may be adapted to the paper and the environmental conditions.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates an example digital printer.

FIG. 2 illustrates an example print group of the digital printer of FIG. 1.

FIG. 3 illustrates a controller according to an exemplary embodiment of the present disclosure.

FIG. 4a illustrates a control loop for the adjustment of the electrical field for an electrographic printing process according to an exemplary embodiment of the present disclosure.

FIG. 4b illustrates a model of the electrical properties of the electrographic printing process according to an exemplary embodiment of the present disclosure.

FIGS. 4c-4e illustrate exemplary correlations between the current and/or the voltage in an electrographic printing process according to exemplary embodiments of the present disclosure.

FIG. 4f illustrates a roller nip between a transfer roller and a counter-pressure roller according to an exemplary embodiment of the present disclosure.

FIG. 5 illustrates a flowchart of an adjustment method of the electrical field for an electrographic printing process according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

The present document deals with the technical object to provide a uniformly high print quality even given different varying framework conditions, i.e. given different values of framework parameters.

In an exemplary embodiment of the present disclosure, a method for setting an electrical field at a transfer point in a printing process is provided. The electrical field is produced by a voltage between a transfer electrode and a counter-electrode. The transfer point is arranged between the transfer electrode and the counter-electrode. A current flows between the transfer electrode and the counter-electrode during the printing process.

In an exemplary embodiment of the present disclosure, the method includes the determination of a current value of one or more framework parameters. The one or more framework parameters thereby have the property that a change to a value of one of the one or more framework parameters also produces a change to the current between the transfer electrode and the counter-electrode, given a constant voltage. In an exemplary embodiment of the present disclosure, the method further includes the adaptation of a control loop for the adjustment of the electrical field depending on the current value of the one or more framework parameters. In an exemplary embodiment of the present disclosure, the method further includes the variation of the voltage between the transfer electrode and the counter-electrode using the adapted control loop.

In an exemplary embodiment of the present disclosure, a controller of a print group of a digital printer is described. In an exemplary embodiment of the present disclosure, the print group comprises a transfer electrode and a counter-electrode to which a voltage may be applied in order to produce an electrical field at a transfer point between the transfer electrode and the counter-electrode. Given an applied voltage, a current flows between the transfer electrode and the counter-electrode. The controller is configured to determine a current value of a framework parameter. In an exemplary embodiment, a change of the value of the framework parameter also produces a change of the current between the transfer electrode and the counter-electrode, given a constant voltage. In an exemplary embodiment of the present disclosure, the controller is configured to adapt a control loop for the adjustment of the field strength of the electrical field depending on the current value of the framework parameter. In an exemplary embodiment, the controller is configured to vary the voltage between the transfer electrode and the counter-electrode using the adapted control loop.

In an exemplary embodiment of the present disclosure, a print group for a digital printer is described. The print group can include the controller described in one or more exemplary embodiments.

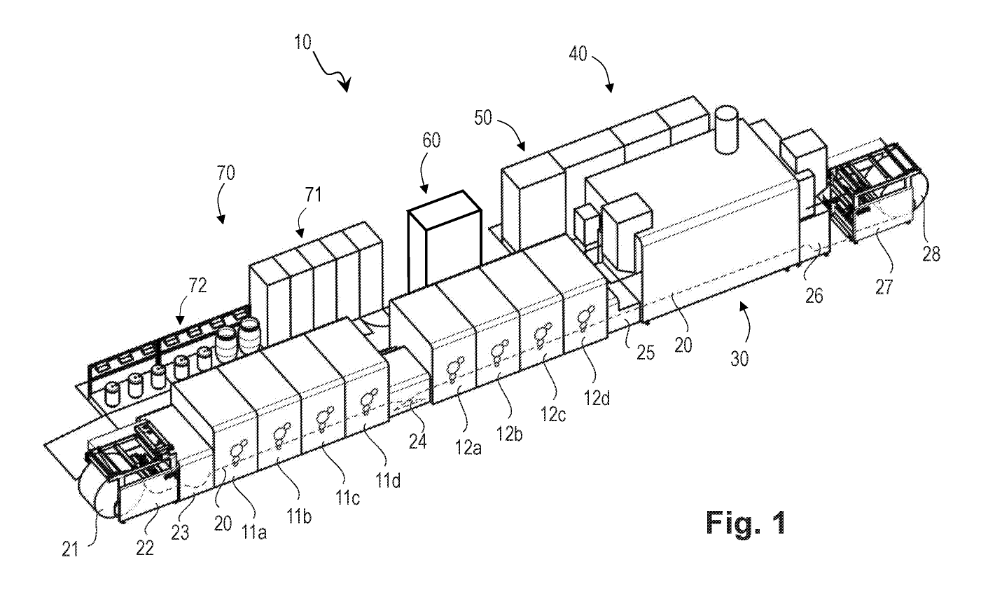

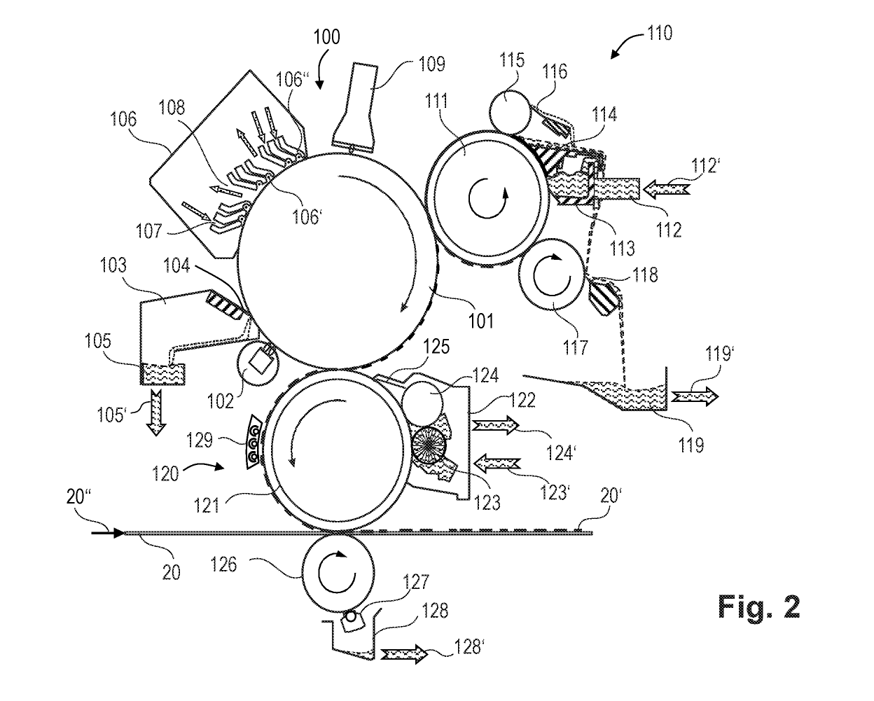

FIG. 1 illustrates an example digital printer 10. The digital printer 10 can be configured to print to a recording medium 20 and includes one or more print groups 11a-11d and 12a-12d that print a toner image (print image 20′; see FIG. 2) onto the recording medium 20. As shown, a web-shaped recording medium 20 (as a recording medium 20) is unrolled from a roll 21 with the aid of a take-off 22 and is supplied to the first print group 11a. The print image 20′ is fixed on the recording medium 20 in a fixer 30. The recording medium 20 may subsequently be taken up on a roll 28 with the aid of a take-up 27. Such a configuration depicted is also designated as a roll-to-roll printer.

Further examples of the digital printer 10 are described in U.S. Patent Application Publication No. 2014/0212632 (of U.S. application Ser. No. 14/166,312), and corresponding German Patent Application No 10 2013 201 549 and Japanese Patent Application No. 2014/149526A. Each of these applications is incorporated herein by reference in their entirety.

FIG. 2 illustrates example print groups 11, 12. The print groups 11, 12 depicted in FIG. 2 are configured to utilize the electrophotographic principle, given which a photoelectric image substrate (in particular a photoconductor 101) is inked with charged toner particles with the aid of a liquid developer, and the toner image that is created in such a manner is transferred to the recording medium 20. In an example of the print groups 11, 12, the print group includes an electrophotography station 100, a developer station 110 and a transfer station 120.

The electrophotography station 100 includes a photoelectric image substrate that has a photoelectric layer (what is known as a photoconductor) on its surface. The photoconductor can be configured as a roller (photoconductor roller 101) and has a hard surface. In operation, the photoconductor roller 101 rotates past the various elements to generate a print image 20′ (rotation in the direction indicated by the arrow).

The electrophotography station 100 includes a character generator 109 that generates a latent image on the photoconductor 101. The latent image is inked with toner particles by the developer station 110 in order to generate an inked image (i.e. a toner image). For this, the developer station 110 has a rotating developer roller 111 that brings a layer of liquid developer onto the photoconductor 101.

The inked image rotates with the photoconductor roller 101 up to a first transfer point, at which the inked image is essentially completely transferred onto a transfer roller 121. The recording medium 20 travels in the transport direction 20″ between the transfer roller 121 and a counter-pressure roller 126. The contact region (nip) represents a second transfer point in which the toner image is transferred onto the recording medium 20. The recording medium 20 may be made of paper, paperboard, cardboard, metal, plastic and/or other suitable and printable materials. Additional details with regard to the print groups 11, 12 are described in U.S. Patent Application Publication No. 2014/0212632, as well as in corresponding German Patent Application No 10 2013 201 549 and Japanese Patent Application No. 2014/149526A.

The printing to a web-shaped recording medium 20 in an electrographic multicolor digital printer 10 with subsequent fixing of the toner image may lead to problems if the thickness or size of the recording medium 20 is significantly thicker than in typical commercial paper types (e.g., for the printing of invoices). For example, this pertains to digital printers 10 for the printing of packaging with grammages of the recording medium 20 of more than 200 g/m², given which a substantial increase of the electrical resistance is typically observed due to the thickness of the recording medium 20.

In the electrographic printing process, and in particular in the electrophoretic printing process, the electrically charged toner particles in the nip (i.e. in the roller gap) between transfer roller 121 and counter-pressure roller 126 are released from the transfer roller 121 and transferred onto the recording medium 20 under the application of mechanical pressure and under the application of an externally applied electrical field. To increase the likelihood of a constant, stable and optimally complete transfer of the toner particles from the transfer roller 121 onto the recording medium 20, the effective active electrical force on the charged toner particles in the nip is set to be sufficiently large and homogeneous. This electrical force is produced by the field strength of the electrical field in the nip.

Due to the design of the print group 11, 12, a suitable potential difference or voltage is typically realized between the electrically conductive (in particular metallic) cores of the transfer roller 121 and the counter-pressure roller 126. In one or more exemplary embodiments of the present disclosure, these cores are also designated as transfer electrode or as counter-electrode. Due to the voltage between transfer electrode and counter-electrode, an effective electrical field appears in the roller nip across the liquid developer (comprised of electrically charged toner particles and carrier fluid) and generates a force on the charged toner particles. This produces a transfer of the toner particles onto the recording medium 20.

In an exemplary embodiment, the electrical field at the roller nip between the transfer roller 121 and the counter-pressure roller 126 is kept within a defined operating range in order to ensure an optimally complete and uniform toner transfer onto the recording medium 20.

The strength of the electrical field thereby depends on a plurality of influencing factors or framework parameters. In particular, the strength of the electrical field depends on the thickness or size of the recording medium 20, on the electrical resistance of the recording medium 20, and/or on the specific resistance of the material of the recording medium 20. Furthermore, the ambient atmosphere in the environment of the nip may have an influence on the strength of the electrical field and on the current flow across the nip. The electrical field in the nip can depend on the electrical properties (in particular on the specific resistance) and on the thickness of the materials that are located between the electrodes (for example the metallic cores and/or the rotation axles) of the transfer roller 121 and the counter-pressure roller 126. For example, the electrical field can depend on the elastomer of the transfer roller 121, on the liquid developer in the roller nip, on the recording medium 20 and on the surface coating of the counter-pressure roller 126. In this resistance chain, the resistance of the recording medium 20 typically represents a substantial component.

The specific resistance of cardboard boxes may vary by up to two orders of magnitude in different climates. The variation of the properties of the recording medium 20 thus produces a significant variation of the electrical field which decreases across the liquid developer in the nip, and therefore a significant variation of the effective force that acts on the charged toner particles. Therefore, given use of a constant voltage which is applied between the cores of the transfer roller 121 and the counter-pressure roller 126, significant variations in the efficiency of the printing process may occur due to moisture and/or temperature fluctuations in the recording medium 20 that is to be printed to. This may lead to substantial fluctuations in the quality of the created print image during the printing to a recording medium 20 of the same roller.

An object of the present disclosure is to provide a consistently high print quality of an electrophotographic digital printer 10 even given changing framework parameters. The present disclosure achieves an optimally complete and uniform toner transfer from the transfer roller 121 onto the recording medium 20 even given changing framework parameters.

In some cases, to increase uniform print quality, measures can be taken to keep the framework parameters the same. For example, climate-sealed packaging of paper rolls may be used in order to ensure an optimally constant moisture within a roll. Furthermore, a digital printer 10 may be climate-controlled in order to keep climatic framework parameters of the printing process constant. Furthermore, voltages and/or currents between transfer roller 121 and counter-pressure roller 126 via which an optimally high and optimally constant print quality is achieved may be determined via empirical evaluations. However, these measures may lead to increased costs and do not always lead to a homogenization of the print quality.

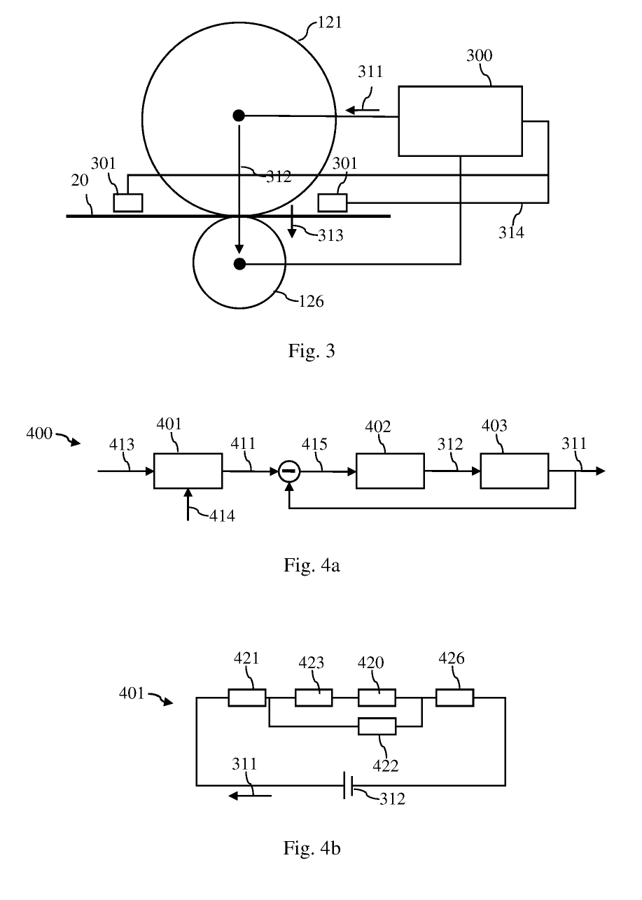

FIG. 3 illustrates a controller 300 according to an exemplary embodiment of the present disclosure. In an exemplary embodiment, the controller 300 is configured to adjust one or more electrical properties of a transfer process from a transfer roller (e.g., transfer roller 121) onto a recording medium (e.g., recording medium 20). In an exemplary embodiment, the controller 300 is configured to adjust the strength of an electrical field 313 at the roller nip between the transfer roller 121 and the counter-pressure roller 126. In this example, the controller 300 can be configured to adapt, regulate and/or otherwise adjust the voltage 312 and/or the current 311 between the electrodes of the transfer roller 121 and the counter-pressure roller 126. The controller 300 can be configured to continuously adapt or regulate the voltage 312 and/or the current 311. The electrodes may be arranged axially in the middle of the transfer roller 121 or, respectively, of the counter-pressure roller 126.

The controller 300 can be an embodiment of the controller 60 or otherwise implemented in the digital printer 10, and configured to control one or more operations (e.g., adapt/regulate/adjust the voltage 312 and/or current 311) of the digital printer 10. The controller 300 can alternatively be implemented in the print group 11, 12 or externally located from the print group 11,12, and be configured to control one or more operations of the print group 11, 12.

In an exemplary embodiment, the controller 300 includes processor circuitry configured to perform one or more operations of the controller 300, including controlling (e.g., adapting, regulating, adjusting) the voltage 312 and/or the current 311.

In an exemplary embodiment, the print group (e.g., 11, 12) can include one or more sensors 301 configured to sense, measure or otherwise determine sensor data 314. The sensor data 314 can indicate current values for framework parameters of the printing process. In an exemplary embodiment, one or more of the following framework parameters may be determined using the sensor data 314:
the temperature of the transfer roller 121 (in particular of the elastomer of the transfer roller 121);
the temperature and/or humidity in the nip and/or in the environment of the nip (in particular in the nip intake and/or in the nip outlet);
the temperature and/or moisture of the recording medium 20 and/or of the environment of the recording medium 20;
one or more electrical parameters (e.g., an electrical resistance and/or a specific electrical resistance) of the recording medium 20;
one or more electrical parameters (e.g., an electrical resistance) of the transfer roller 121 and/or of the counter-pressure roller 126;
one or more electrical parameters (an electrical resistance) of the liquid developer;
a width (transversal to the transport direction 20″) of the recording medium 20 and/or a longitudinal electrical resistance (transversal to the transport direction 20″) of the recording medium 20;
a thickness of the recording medium 20 and/or a volume electrical resistance of the recording medium 20;
a mechanical force with which the transfer roller 121 is pressed onto the recording medium 20;
an elastic behavior of the transfer roller 121; and/or
temperature and/or ambient humidity of the printer 10 or of the space/environment in which the printer 10 is located.

As illustrated in FIG. 3, in an exemplary embodiment, the one or more sensors 301 are arranged before and/or after the transfer roller 121. In this example, the one or more sensors 301 are arranged before and/or after the transfer point in the transport direction 20″.

In an exemplary embodiment, the information with regard to the current values of one or more framework parameters of the printing process (e.g., the width of the recording medium 20) may, if applicable, be determined via a manual input by, for example, one or more users of the digital printer 10.

In an exemplary embodiment, the controller 300 can be configured to adapt/adjust the current 311 and/or the voltage 312 based on the determined information with regard to the current values of the framework parameters. For example, the current 311 and/or the voltage 312 may be adapted such that the strength of the electrical field 313 in the nip remains within a predefined field strength range (i.e. with a predefined operating range), even given changing values of the framework parameters.

In an exemplary embodiment, the controller 300 can be configured to regulate the current 311 and/or the voltage 312 to adapt/adjust the current 311 and/or the voltage 312 based on one or more framework parameters. The current values of the framework parameters may thereby be taken into account, including, for example, the current ambient atmosphere of the digital printer 10, the current temperature of the transfer roller (in particular of the elastomer layer 121), the current ambient atmosphere of the recording medium 20 and/or a current parasitic current between transfer roller 121 and counter-pressure roller 126. The effective electrical field in the liquid developer in the nip may be kept within an optimal operating range via such a regulation.

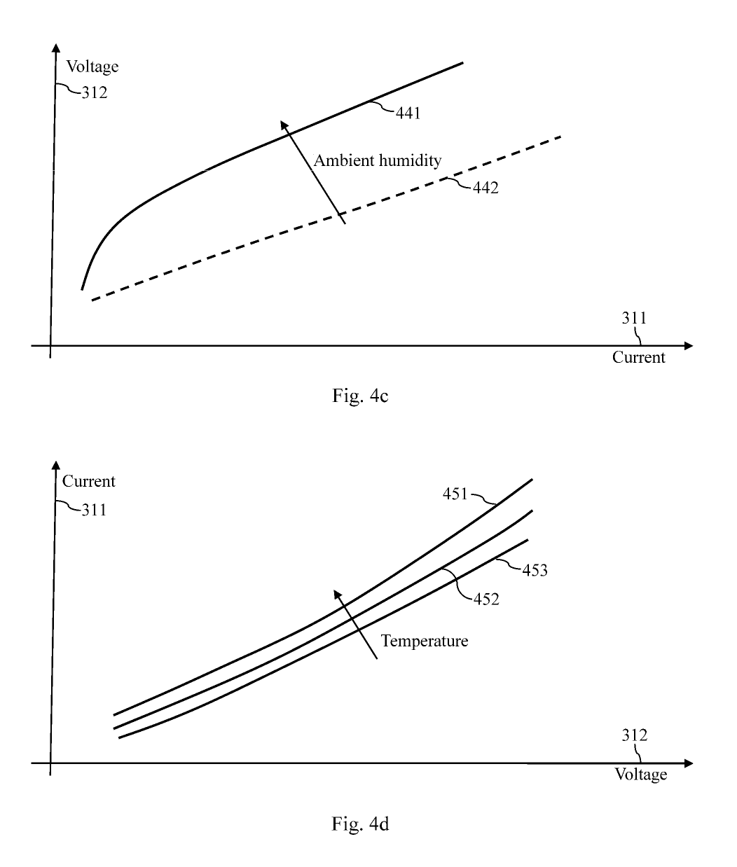

FIG. 4c illustrates an example of the influence of the ambient atmosphere of the digital printer 10 on the correlation between the voltage 312 and the current 311 between the transfer roller 121 and the counter-pressure roller 126. For example, FIG. 4c shows two characteristic lines 441, 442 for different ambient atmospheres. The ambient atmosphere (room atmosphere) thereby affects the moisture of the recording medium 20 in the unrolled state. The moisture of the recording medium 20 typically decreases due to a dry ambient atmosphere, whereby the resistance of the recording medium 20 increases.

FIG. 4d illustrates an example of the influence of the temperature of the recording medium 20 on the correlation of the voltage 312 and the current 311 between the transfer roller 121 and the counter-pressure roller 126. For example, FIG. 4d shows three characteristic lines 451, 452, 453 for different temperatures of the recording medium 20. The electrical resistance of the recording medium 20 may vary with changing temperature.

For specific types of recording media 20, the paper climate (which determines the electrical properties of the recording medium 20) correlates relatively well with the ambient paper atmosphere (i.e. with the humidity and the air temperature) that is measured directly at the take-off gap of the roll 21. The possibility to precisely determine the current values of the electrical properties of the recording medium 20 thus results via the determination of the ambient paper atmosphere.

The temperature of the transfer roller 121 typically has an influence on the resistance of the elastomer layer and on the current flow across the elastomer layer. The electrical resistance of the elastomer layer of the transfer roller 121 may be determined precisely via the measurement of the temperature of the transfer roller 121 and via the consideration of a predetermined characteristic line.

The consideration of the current values of framework parameters of the printing process enables an adaptive control algorithm or an adaptive control loop to be provided that updates the applied voltage 312 and/or current 311 (e.g., the impressed integral current 311) such that the process-relevant effective electrical field (which falls off across the developer fluid) remains in an optimal field strength range (even given changing values of the framework parameters). In one or more embodiments, the control loop may be adapted continuously to respective current values of the framework parameters.

In an exemplary embodiment, given the provision of a regulation with incorporation of current 311 and voltage 312, the total current 311 flowing across the roller contact is typically composed of multiple contributions. The major contribution is thereby most often the current through the recording medium 20 and through the liquid developer. In addition to this, parasitic currents in a paperless part of the roller gap (e.g., nip) may flow as a second contribution, in particular given relatively small paper width. An example of this is depicted in FIG. 4e, which shows the total current 461 between transfer roller 121 and counter-pressure roller 126 given consideration of the parasitic current (473 in FIG. 4f) and the current portion 474 that flows across the recording medium 20. Voltage- and material-dependent contributions from a corona current in the intake or outlet of the nip may contribute as a third current component to the total current 311.

FIG. 4f illustrates the roller nip between a transfer roller 121 and a counter-pressure roller 126 according to an exemplary embodiment. The transfer roller 121 incudes, on the surface, an elastomer layer 475. The recording medium 20 is directed through and between the transfer roller 121 and the counter-pressure roller 126. Furthermore, the voltage 312 is applied between the rotation axle 471 of the transfer roller 121 and the counter-pressure roller 126, whereby a current 474 across the recording medium 20 is produced.

In an exemplary embodiment, the recording medium 20 may not cover the entire length of the rollers 121, 126. A region 472 of the roller nip is thus created in which the transfer roller 121 is in direct contact with the counter-pressure roller 126. In this region 472, a parasitic current 473 may flow past the recording medium 20. In particular, due to the mechanical pressure between transfer roller 121 and counter-pressure roller 126 the elastomer layer 475 may form an electrical connection path between transfer roller 121 and counter-pressure roller 126, via which a parasitic current 473 may flow.

The parasitic current 473 and the current 474 are components of the total current 311.

In an exemplary embodiment, a control algorithm of the control loop may take into account a mathematical model (for example, a mathematical model for the controlled system between the transfer electrode and the counter-electrode). This model may be determined theoretically and/or experimentally. In particular, the physical correlations of the controlled system may be taken into account to determine a model. Moreover, model parameters of the model may be determined from a plurality of experimental measurements of the system response of the controlled system given a known input and/or given known values of one or more framework parameters.

FIG. 4a illustrates a control loop 400 according to an exemplary embodiment of the present disclosure. In this example, the control loop 400 of the current 311 between the transfer roller 121 and the counter-pressure roller 126 (as a controlled variable) is shown. Using an adaptive model 401, a nominal current 411 (as an adaptive reference variable) that should flow between the transfer roller 121 and the counter-pressure roller 126 may be determined from a nominal field strength 413 of the electrical field 313 at the nip. In an exemplary embodiment, the adaptive model 401 used to determine the nominal current 411 depends on the current values of the framework parameters 414 of the printing process. For example, the current values of the framework parameters 414 may be determined on the basis of sensor data 314. The nominal current 411 may thus be adapted to the current values of the framework parameters 414.

The currently measured current 311 may be subtracted from the current nominal current 411 to determine a control error 415. Using a controller 402 (for example a controller with a P(roportional), an I(ntegral) and/or a D(ifferential) calculator), the voltage 312 that is to be set between transfer roller 121 and counter-pressure roller 126 may be determined (as a control variable). In an exemplary embodiment, the controller 402 includes processor circuitry configured to perform one or more operations of the controller 402. In an exemplary embodiment, the controller 300 includes the controller 402. In operation, the current 311 is produced through the controlled system 403 (i.e. the path between transfer roller 121 and counter-pressure roller 126), which current 311 is then compared again with the nominal current 411. In this example, the nominal current may have been updated (e.g., based on the framework parameter(s)) prior to the comparison with the current 311.

FIG. 4b illustrates an adaptive model 401 according to an exemplary embodiment of the present disclosure. In an exemplary embodiment, the adaptive model 401 is an adaptive model of the controlled system 403 from FIG. 4a. In an exemplary embodiment, the model 401 comprises a first electrical resistance 421, a second electrical resistance 423, a third electrical resistance 420, a fourth electrical resistance 422, and a fifth electrical resistance 426.

The first electrical resistance 421 can correspond to the electrical resistance of transfer roller 121 (in particular of the elastomer layer of the transfer roller 121). The first electrical resistance 421 can depend on the temperature of the transfer roller 121.

The second electrical resistance 423 can correspond to the electrical resistance of the filled (typically with liquid developer and possibly with toner) roller nip. The second electrical resistance 423 may depend on the quantity of toner (for example on the number of toner layers) that is located in the roller nip between transfer roller 121 and recording medium 20.

The third electrical resistance 420 can correspond to the electrical resistance of the recording medium 20. The third electrical resistance 420 may depend on the voltage drop at the third electrical resistance, on the temperature of the recording medium 20, on the specific electrical resistance of the material of the recording medium 20 and/or on the moisture of the recording medium 20. Due to the fiber structure, a paper-based recording medium 20 thereby does not have a homogeneous electrical resistance along the roller nip. Therefore, a mean electrical resistance is possibly considered as a third resistance 420.

The fourth electrical resistance 422 can correspond to the electrical resistance of the electrical connection between transfer roller 121 and counter-pressure roller 126 which is directed past the recording medium 20. The fourth electrical resistance 422 may be used to model the aforementioned parasitic current 473. The fourth electrical resistance 422 is may be dependent on the width and the thickness of the recording medium 20 and/or on the mechanical pressure with which the counter-pressure roller 126 is pressed on the transfer roller 121.

Moreover, the fifth electrical resistance 426 can correspond to the electrical resistance of the counter-pressure roller 126. For example, the fifth electrical resistance 426 is dependent on the ambient temperature and/or on the ambient humidity.

Characteristic lines (as shown in FIGS. 4c, 4d, 4e) may be stored for the individual resistances 421, 423, 420, 422, 426 (i.e. for the individual model parameters), which characteristic lines reflect a correlation between the resistances 421, 423, 420, 422, 426 and the current values of the framework parameters 414. These characteristic lines may be determined theoretically and/or experimentally. The current values of the individual resistances 421, 423, 420, 422, 426 (i.e. the current values of the model parameters) may thus be determined by determining the current values of the framework parameters 414. The model 401 may thus be adapted virtually continuously to the current values of the framework parameters.

The voltage drop at the second electrical resistance 423 determines the field strength of the electrical field 313 at the nip. Given knowledge of the current values of the individual resistances 421, 423, 420, 422, 426, the current 311 via which a specific voltage drop at the second electrical resistance 423 is produced may be determined using the model 401. In other words: the nominal current 411 via which an electrical field 313 with the nominal field strength 413 is produced may be determined using the model 401. This nominal current 411 may then be set and adapted to modified values of the framework parameters 414 using the control loop 400. It may thus be achieved that an electrical field 313 with consistent nominal field strength 413 is present at the nip even given a change to the values of the framework parameters 414, meaning that a consistently high print quality is achieved.

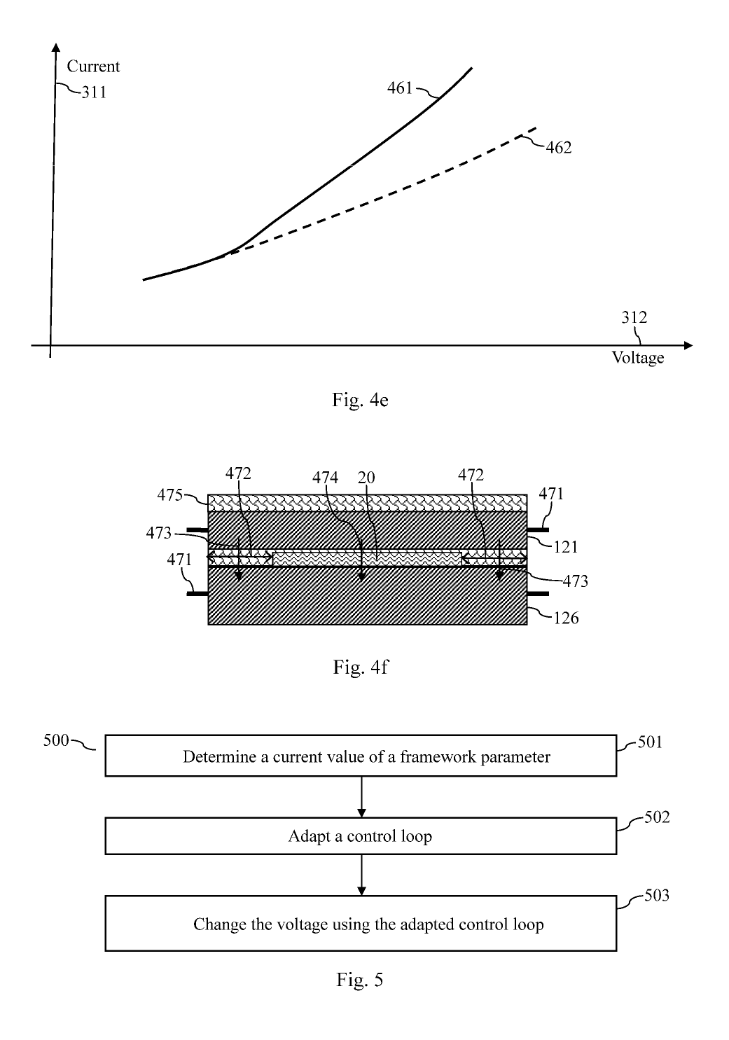

FIG. 5 illustrates a flowchart of a method 500 to set an electrical field 313 at a transfer point in an electrographic (in particular an electrophotographic) printing process. In an exemplary embodiment, the field strength of the electrical field 313 at the roller nip between a transfer roller 121 and a counter-pressure roller 126 may be set via the method 500, for example to a specific nominal field strength 413 to produce a uniform, reliable toner transfer onto a recording medium 20.

The electrical field 313 is produced by a voltage 312 between a transfer electrode (which is arranged at or in the transfer roller 121, for example) and a counter-electrode (which, for example, is arranged on or in the counter-pressure roller 126), wherein the transfer point is arranged between the transfer electrode and the counter-electrode. In particular, the transfer point may be the roller nip between the transfer roller 121 and the counter-pressure roller 126. A current 311 typically flows between the transfer electrode and the counter-electrode during the printing process. The level of the current 311 thereby also depends on the electrical properties of the path between transfer electrode and counter-electrode, in addition to being dependent on the applied voltage 312. These electrical properties can depend on the current values of the framework parameters 414 for the electrographic printing process.

The electrical properties of the path between the transfer electrode and the counter-electrode typically include the electrical properties of the transfer roller 121 via which the toner image is conveyed at the transfer point; the electrical properties of the recording medium 20 onto which the toner image is transferred at the transfer point; the electrical properties of the nip between transfer roller and recording medium 20 at the transfer point;

and/or the electrical properties of the counter-pressure roller 126 via which the recording medium 20 is pressed against the transfer roller 121.

In an exemplary embodiment, the method 500 includes the determination 501 of a current value of a framework parameter 414 of the printing process. In this example, a change to the framework parameter 414 produces a change to the current 311 between the transfer electrode and the counter electrode, even given a constant voltage 312. In other words: the framework parameter 414 has an influence on the electrical properties of the path between transfer electrode and counter-electrode. Current values for a plurality of framework parameters 414 may be analogously determined.

In an exemplary embodiment, the framework parameters 414 may include one or more of: a thickness and/or a width of the recording medium 20 that is arranged between the transfer electrode and the counter-electrode during the printing process; a temperature of the recording medium 20; a moisture of the recording medium 20; a conductivity and/or an electrical resistance of the recording medium 20; a temperature and/or a moisture in an environment of the transfer point; a temperature of the transfer roller 121 and/or of the counter-pressure roller 126, wherein the transfer roller 121 comprises the transfer electrode and the counter-pressure roller 126 comprises the counter-electrode; and/or a conductivity and/or an electrical resistance of the transfer roller 121 and/or of the counter-pressure roller 126; a mechanical force with which the counter-pressure roller 126 is pressed onto the transfer roller 121; and/or a length of the counter-pressure roller 126 and/or the transfer roller 121 transversal to the transport direction 20″ of the recording medium 20.

In an exemplary embodiment, the values of one or more framework parameters 414 may be determined from a database, for example the dimensions of the recording medium 20 and/or of the printer 10 (for example the length of the rollers 121, 126). For example, the length of the region 472 of the roller nip in which no recording medium 20 is located may be determined from this information.

In an exemplary embodiment, the method 500 may include the determination of sensor data 314 of one or more sensors 301. The one or more sensors 301 can be configured to detect one or more of the aforementioned framework parameters 414. For example, one or more temperature values may be determined by a temperature sensor and/or one or more moisture values may be determined using a moisture sensor. A current value of a framework parameter 414 may thus be determined on the basis of the sensor data 314.

In an exemplary embodiment, the method 500 additionally includes the adaptation 502 of a control loop 400 for adjustment of the electrical field 313 depending on the current value of the framework parameter 414. For example, the voltage 312 and/or the current 311 may be regulated using a control loop 400 in order to ensure a uniform toner transfer. The control loop 400 that is used for the voltage regulation and/or current regulation may thereby be adapted continuously to current values of one or more framework parameters 414. It may thus be ensured that a uniform print quality is achieved even given changing framework conditions (i.e. given changing values of one or more framework parameters 414).

In an exemplary embodiment, the method 500 additionally includes the variation 503 of the voltage 312 between the transfer electrode and the counter-electrode using the adapted control loop 400.

The control loop 400 may include an (adaptive) model 401 of an electrical connection path between transfer electrode and counter-electrode. In other words, the electrical properties of the path between transfer electrode and counter-electrode may be described by a model 401. For example, the model may indicate which electrical field appears at the transfer point (for example at the roller nip) given a specific current 311 and/or given a specific voltage 312. The model 401 may assume a multitude of different forms.

In an exemplary embodiment, the model 401 may be adapted to current values of one or more framework parameters 414. Such an adapted model 401 may then be used to adapt a reference value of the control loop 400 (for example a nominal current 411 or a nominal voltage) to the current values of the one or more framework parameters 414, in order to ensure that—given use of the continuously adapted reference value—the electrical field 313 has a constant nominal field strength 413 at the transfer point (even given changing values of the one or more framework parameters 414).

For example, the model 401 may indicate via which nominal current 411 and/or via which nominal voltage between the transfer electrode and the counter-electrode a corresponding nominal field strength 413 of the electrical field 313 is produced at the transfer point. Using a model 401 which is adapted continuously to the current value of one or more framework parameters 414, a (continuously) changing nominal current 411 or a (continuously) changing nominal voltage may then be determined as a reference value of the control loop 400 via which a constant nominal field strength 413 is produced.

In an exemplary embodiment, the model 401 may include a plurality of model parameters 420, 421, 422, 423, 426, in particular one or more electrical resistances, and the plurality of model parameters 420, 421, 422, 423, 426 may be adapted depending on the current value of the framework parameters 414. For this, one or more (possibly experimentally determined) characteristic lines 441, 442, 451, 452, 453, 461, 462 may be used that indicate how one or more of the model parameters 420, 421, 422, 423, 426 vary in reaction to a change of a value of a framework parameter 414.

As illustrated in FIG. 4a, the current 311 between the transfer electrode and the counter-electrode may represent a controlled variable of the control loop 400. The voltage 312 between the transfer electrode and the counter-electrode may represent a control variable of the control loop 400. In an exemplary embodiment, the control loop 400 can be configured to regulate the current 311 between the transfer electrode and the counter-electrode according to a nominal current 411 as a reference variable.

In particular, the temperature of the recording medium 20 may have a substantial influence on the transversal resistance 420 of the recording medium 20. To reduce the required voltage 312 (and for an improvement of the toner transfer that is linked with this), it may be advantageous to warm the recording medium 20 before reaching the transfer point (i.e. the roller nip), such that the transversal resistance of the recording medium 20 is reduced for the toner transfer.

In an exemplary embodiment, the method 500 may therefore include the tempering (in particular the warming) of the recording medium 20 before the transfer of the charged toner particles. The electrical resistance of the recording medium 20 (in particular the transversal resistance or the volume resistance of the recording medium 20) for the toner transfer may be reduced via the tempering of the recording medium 20 (in particular via the warming of the recording medium 20). The tempered recording medium 20 may then be directed to or through the transfer point, such that the charged toner particles at the transfer point transfer over from the transfer electrode onto the tempered recording medium 20 under the effect of the electrical field 313.

Via the tempering 501 of the recording medium 20, the voltage 312 may be reduced (in comparison to an untampered recording medium 20), which is necessary in order to generate an electrical field 313 with a specific nominal field strength 413. The reduction of the voltage 312 is thereby achieved via the reduction of the electrical resistance 452 of the recording medium 20. Artifacts in the toner transfer are avoided via the reduction of the voltage 312, such that the transfer of the charged toner particles may be improved overall. In particular, breakdowns through the recording medium 20 and/or recharging processes of toner particles may be avoided.

In an exemplary embodiment, the model 401 of the electrical connection path between transfer electrode and counter-electrode may depend on whether toner is located in the roller nip and/or the quantity of the toner located in the roller nip. For example, the resistance 423 of a resistance model 401 may depend on whether and/or how much toner is located in the roller nip. The quantity of toner in the roller nip may be determined using print data and/or sensor data with regard to a print image which should be printed onto the recording medium 20 at the transfer point (i.e. at the roller nip) and/or that is already located on the recording medium 20 at the transfer point. The model 401 which is used for the regulation of the current 311 and/or of the voltage 312 may thus depend on the print data and/or the sensor data. The adjustment of the electrical field 313, and the toner transfer resulting from this, may thus be further improved.

In an exemplary embodiment, in a manner analogous to the method 500, the controller 300 can be configured to determine a current value of a framework parameter 414. In particular, the current values of one or more framework parameters 414 may be determined regularly with a predefined sampling rate (of 1 Hz, for example). The controller 300 may additionally be configured to adapt a control loop 400 for the adjustment of the field strength of the electrical field 313 depending on the current values of the one or more framework parameters 414. In particular, the control loop 400 may be adapted to the current values of the one or more framework parameters 414 with the aforementioned sampling rate. Furthermore, the controller 300 may be configured to vary the voltage 312 between the transfer electrode and the counter-electrode using the adapted control loop 400 (for example in order to regulate the current 311 according to a current nominal current 411).

Via the measures described in this document, the transfer efficiency of an electrographic digital printer 10 may be kept optimal, even given changing framework parameters. A cost-effective climate control of the digital printer 10 is unnecessary. Different climates and material fluctuations in the recording medium 20 within a roll 21, different ambient atmospheres and fluctuations during the printing operation, and/or different widths of recording media 20 may be reacted to flexibly. The operating cost of a digital printer 10 may be significantly reduced via the automatic consideration of current values of framework parameters 414, since manual adaptations of the settings of the digital printer 10 are dispensed with.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, processor circuitry can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

10 digital printer
11, 11a-11d print group (front side)
12, 12a-12d print group (back side)
20 recording medium
20′ print image (toner)
20″ transport direction of the recording medium
21 roll (input)
22 take-off
23 conditioning group
24 turner
25 register
26 drawing group
27 take-up
28 roll (output)
30 fixer
40 climate controller
50 power supply
60 controller
70 fluid management
71 fluid controller
72 reservoir
100 electrophotography station
101 image substrate (photoconductor, photoconductor roller)
102 erasure light
103 cleaning device (photoconductor)
104 blade (photoconductor)
105 collection container (photoconductor)
106 charging device (corotron)
106′ wire
106″ shield
107 supply air channel (aeration)
108 exhaust air channel (ventilation)
109 character generator
110 developer station
111 developer roller
112 storage chamber
112′ fluid supply
113 pre-chamber
114 electrode segment
115 dosing roller (developer roller)
116 blade (dosing roller)
117 cleaning roller (developer roller)
118 blade (cleaning roller of the developer roller)
119 collection container (liquid developer)
119′ fluid discharge
120 transfer station
121 transfer roller
122 cleaning unit (wet chamber)
123 cleaning brush (wet chamber)
123′ cleaning fluid discharge
124 cleaning roller (wet chamber)
124′ cleaning fluid discharge
125 blade
126 counter-pressure roller
127 cleaning unit (counter-pressure roller)
128 collection container (counter-pressure roller)
128′ fluid discharge
129 charging unit (corotron at transfer roller)
300 controller
301 sensor
311 current (between transfer roller 121 and counter-pressure roller 126)
312 voltage (between transfer roller 121 and counter-pressure roller 126)
313 electrical field (at the roller nip)
314 sensor data
400 control loop
401 model
402 controller
403 controlled system
411 nominal current
413 nominal field strength
414 framework parameter
415 control error
420, 421, 422, 423, 426 model parameter (electrical resistances)
441, 442, 451, 452, 453, 461, 462 characteristic lines
471 rotation axle
472 region of the roller nip without recording medium
473 parasitic current
474 current through recording medium
475 elastomer layer of the transfer roller
500 method to adjust an electrical field
501, 502, 503 method steps

What is claimed is:

1. A method to adjust an electrical field at a transfer point in an electrographic printing process, the electrical field being produced by a voltage between a transfer electrode and a counter-electrode, during the printing process, a current flowing between the transfer electrode and the counter-electrode, and the transfer point being arranged between the transfer electrode and the counter-electrode, the method comprising:
determining a current value of a framework parameter, a change to a value of the framework parameter producing a change to the current between the transfer electrode and the counter-electrode even given a constant voltage;
adapting a control loop to adjust the electrical field based on the current value of the framework parameter, wherein the control loop includes a model of an electrical connection path between the transfer electrode and the counter-electrode, the model being adapted based on the current value of the framework parameter; and
modifying the voltage between the transfer electrode and the counter-electrode based on the adapted control loop.

2. The method according to claim 1, wherein the model indicates via which nominal current and/or via which nominal voltage between the transfer electrode and the counter-electrode a corresponding nominal field strength of the electrical field is produced at the transfer point.

3. The method according to claim 1, wherein the electrical connection path between the transfer electrode and the counter-electrode comprises:
a transfer roller via which a toner image is conveyed to the transfer point;
a recording medium onto which the toner image is transferred at the transfer point;
a nip between the transfer roller and the recording medium at the transfer point; and
a counter-pressure roller via which the recording medium is pressed against the transfer roller.

4. The method according to claim 1, wherein:
the model includes a plurality of model parameters; and
the plurality of model parameters are adapted based on the current value of the framework parameter.

5. The method according to claim 1, wherein:
the current between the transfer electrode and the counter-electrode represents a controlled variable of the control loop;
the voltage between the transfer electrode and the counter-electrode represents a control variable of the control loop; and
the control loop is configured to regulate the current between the transfer electrode and the counter-electrode based on a nominal current as a reference variable.

6. The method according to claim 5, wherein the nominal current is adapted based on the current value of the framework parameter.

7. The method according to claim 1, further comprising:
determining sensor data using one or more sensors, wherein the current value of the framework parameter is determined based on the sensor data.

8. The method according to claim 1, wherein the framework parameter includes one or more of:
a thickness of a recording medium that is arranged between the transfer electrode and the counter-electrode during the electrographic printing process;
a width of the recording medium that is arranged between the transfer electrode and the counter-electrode during the electrographic printing process;
a temperature of the recording medium;
a moisture of the recording medium;
a conductivity of the recording medium;
an electrical resistance of the recording medium;
a temperature in an environment of the transfer point;
a moisture in the environment of the transfer point;
a temperature of a transfer roller, wherein the transfer roller includes the transfer electrode;
a temperature of a counter-pressure roller, wherein the counter-pressure roller includes the counter-electrode;
a conductivity of the transfer roller and/or of the counter-pressure roller;
an electrical resistance of the transfer roller and/or of the counter-pressure roller;
a mechanical force with which the counter-pressure roller is pressed onto the transfer roller; and
a length of the counter-pressure roller and/or of the transfer roller transversal to a transport direction of the recording medium.

9. A computer program product embodied on a computer-readable medium comprising program instructions, when executed, causes a processor to perform the method of claim 1.

10. A controller operable in a print group of an electrographic digital printer, the print group including a transfer electrode and a counter-electrode at which a voltage may be applied to produce an electrical field at a transfer point between the transfer electrode and the counter-electrode, wherein given an applied voltage, a current flows between the transfer electrode and the counter-electrode; the controller being configured to:
determine a current value of a framework parameter, a change to a value of the framework parameter producing a change to the current between the transfer electrode and the counter-electrode even given a constant voltage;
adapt a control loop to adjust a field strength of the electrical field based on the current value of the framework parameter, wherein the control loop includes a model of an electrical connection path between transfer electrode and counter-electrode, the model being adapted based on the current value of the framework parameter; and
modify the voltage between the transfer electrode and the counter-electrode based on the adapted control loop.

11. A method to adjust an electrical field at a transfer point in an electrographic printing process, the electrical field being produced by a voltage between a transfer electrode and a counter-electrode, during the printing process, a current flowing between the transfer electrode and the counter-electrode, and the transfer point being arranged between the transfer electrode and the counter-electrode, the method comprising:
determining a framework parameter value corresponding to a characteristic of a recording medium onto which a toner image is transferred at the transfer point, wherein the current between the transfer electrode and the counter-electrode being dependent on the framework parameter value;
adjusting the electrical field based on the framework parameter value; and
modifying the voltage between the transfer electrode and the counter-electrode based on the adjusted electrical field.

12. The method according to claim 11, wherein the electrical connection path between the transfer electrode and the counter-electrode comprises:
a transfer roller via which the toner image is conveyed to the transfer point;
the recording medium onto which the toner image is transferred at the transfer point;
a nip between the transfer roller and the recording medium at the transfer point; and
a counter-pressure roller via which the recording medium is pressed against the transfer roller.

13. The method according to claim 11, further comprising:
determining first sensor data using a first sensor positioned adjacent to the recording medium before the transfer point with respect to a transport direction of the recording medium; and
determining second sensor data using a second sensor positioned adjacent to the recording medium after the transfer point with respect to the transport direction of the recording medium,
wherein the framework parameter value is determined based on the first sensor data and the second sensor data.

14. The method according to claim 11, wherein the characteristic of the recording medium includes one or more of:
a thickness of the recording medium that is arranged between the transfer electrode and the counter-electrode during the electrographic printing process;
a width of the recording medium that is arranged between the transfer electrode and the counter-electrode during the electrographic printing process;
a temperature of the recording medium;
a moisture of the recording medium;
a conductivity of the recording medium; and
an electrical resistance of the recording medium;

15. The method according to claim 11, wherein the framework parameter value further corresponds to a characteristic of a printer configured to perform the electrographic printing process.

16. The method according to claim 15, wherein the characteristic of the printer includes one or more of:
a temperature in an environment of the transfer point;
a moisture in the environment of the transfer point;
a temperature of a transfer roller, wherein the transfer roller includes the transfer electrode;
a temperature of a counter-pressure roller, wherein the counter-pressure roller includes the counter-electrode;
a conductivity of the transfer roller and/or of the counter-pressure roller;
an electrical resistance of the transfer roller and/or of the counter-pressure roller;
a mechanical force with which the counter-pressure roller is pressed onto the transfer roller; and
a length of the counter-pressure roller and/or of the transfer roller transversal to a transport direction of the recording medium.

17. A computer program product embodied on a computer-readable medium comprising program instructions, when executed, causes a processor to perform the method of claim 11.

18. A controller of a printer configured to perform the electrographic printing process, the controller being configured to perform the method of claim 11.
